(19) United States
(12) Patent Application Publication
(10) Pub. No.: US 2003/0183811 A1
(43) Pub. Date: Oct. 2, 2003

(54) Coating solution, preparing method thereof and optical material

(75) Inventors: Tomozumi Uesaka, Minamiashigara-shi (JP); Yasuhiro Yamaguchi, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/283,111

(22) Filed: Oct. 30, 2002

(30) Foreign Application Priority Data
Mar. 20, 2002 (JP) 2002-078861

(51) Int. Cl. G03C 1/00

(52) U.S. Cl. 252/582

(57) ABSTRACT

A preparing method of a coating solution includes the steps of preparing a solution containing an organic non-linear molecule having one or more hydrolyzable silicon substituent groups, contacting the solution with a solid catalyst for sufficient time, and separating the solution from the solid catalyst.

### BACKGROUND OF THE INVENTION

1. Field of the Invention

The present invention relates to a coating solution for production of a non-linear optical material applicable to such fields as optical information processing and optical communication at high speed and large capacity and image processing, as well as a non-linear optical material produced by using the coating solution and a method for producing the non-linear optical material.

More specifically, the present invention relates to a coating solution for production of a non-linear optical material applicable to various devices such as those utilizing an electro-optical effect which is a secondary non-linear optical characteristic, e.g., optical switch, optical modulator, wavelength transformer, wave front transformer, memories (two- and three-dimensional) which utilize a photorefractive effect, and various image processing devices, and further relates to a non-linear optical material produced using the coating solution, and a method for producing the non-linear optical material.

2. Description of the Related Art

Organic non-linear optical materials of a single crystal have been widely studies for example as second harmonic generators (SHG). In the case where the crystal structure of an organic non-linear optical material is a single crystal, organic molecules having a non-linear optical characteristic can be arranged in high orientation and high density, thus allowing a merit of affording a large non-linear optical constant. However, producing a large single crystal with few defects is difficult not only technically but also costwise. Particularly, as to organic molecules having a non-linear optical characteristic free of inversion symmetry, it has not been easy to effect crystallization while arranging them in a specific polarization direction.

As compounds overcoming these difficulties there are known such non-linear optical polymers as an organic non-linear optical polymer prepared by adding an organic compound having a non-linear optical characteristic into a polymer matrix and a main chain type or side chain type organic non-linear optical polymer prepared by introducing a structure (chromophore) having a non-linear optical characteristic into the main chain or side chain of a polymer.

Like ordinary polymers, those non-linear optical polymers can be formed into films easily by dissolving them in solvents or the like and by subsequent application and drying. After the formation into films, if the films are subjected to orienting treatment by the application of an electric field in a heated state thereof to a temperature above their glass transition temperatures (Tg), it is possible to orient their molecules in the polarization direction of the foregoing organic non-linear optical polymer or in the polarization direction of the chromophore moiety of the foregoing organic non-linear optical polymer having the chromophore.

The orientation thus obtained is maintained somewhat stable by removing the electric field after reducing the temperature below Tg. Such orienting treatment is generally called poling treatment. As the method for applying an electric field there are known, for example, a method in which any of the foregoing non-linear optical polymers is sandwiched in between two or more electrodes and an electric field is applied to the polymer, or a method in which an electric field is applied through a medium such as liquid between the non-linear optical polymer and electrodes, or a method in which an electric field is applied to the non-linear optical polymer indirectly by corona discharge.

Non-linear optical polymers having been subjected to such poling treatment have been studied as a substitute for a wavelength transforming crystal such as SHG, but their application to devices utilizing an electro-optic effect (EO effect) which is a secondary non-linear optical effect) such as optical switch, optical modulator, wavelength transformer, and wave front transformer as well as their application as memories utilizing a photorefractive effect or as image processing devices have also been studied (Toshikuni KAINO, FUNCTIONAL MATERIALS, Vol. 18, No. 7, p. 41 (1998)).

Recently, materials having large electro-optic coefficients (EO coefficients) have come to be developed and waveguide type high-speed optical modulators, e.g., Mach-Zender interferometer, using such materials have been proposed and are expected as a new optical device (H. Zhang, et al., Appl. Phys. Lett., Vol. 78, p. 3136 (2001)).

In the non-linear optical polymer having been subjected to the poling treatment, there gradually proceeds disturbance of molecular orientation or re-homogenization caused by molecular vibration for example, i.e., relaxation of molecular orientation, even at a temperature below Tg, thus giving rise to a serious problem that the EO coefficient deteriorates (lowers) with time and thermally. Moreover, if the energy density of laser beam used in the associated device is enhanced, not only relaxation of orientation caused by an increase of temperature but also deterioration caused by a photochemical reaction poses a problem.

For solving these problems, studies are being made about a method in which, using a thermosetting resin as a matrix, the matrix is crosslinked and cured almost simultaneously with poling treatment, and a method in which a reactive substituent is introduced into a non-linear optical molecule itself and crosslinking and curing are allowed to take place with use of another reactive compound (a so-called crosslinking agent) (Y. Shi, et al., Appl. Phys. Lett., Vol. 68, p. 1040 (1996)).

In all of the above methods, the molecular motion is limited (i.e., Tg is made large) by introducing a crosslinked structure into the matrix and the relaxation of chromophore orientation by a thermal molecular vibration for example is prevented, whereby it is intended to improve the stability as the non-linear optical material. Further, it is presumed that by introducing a crosslinked structure into the matrix the deformation of chromophore is suppressed and the reactivity of chromophore itself decreases and that therefore the stability against a photochemical deterioration is improved.

As another method for introducing a non-linear optical molecule into a matrix having a crosslinked structure there is known a method in which a non-linear optical molecule is introduced through covalent bonds into a matrix of a composite organic inorganic material formed by a sol-gel method.

As an example of such a method there has been proposed a method in which, for example, hydrosilyl or alkoxysilyl groups are introduced into plural sites of a non-linear optical molecule, thereby strongly restricting the molecular motion after crosslinking to prevent relaxation of a molecular orientation obtained by poling treatment (S. Kalluri et al., Appl. Phys. Lett., Vol. 65, p. 2651 (1994)). There also has been proposed a photorefractive material with a photoconductive molecule introduced into such a matrix as mentioned above (F. Chaput et al., Chem. Mater., Vol. 8, p. 312 (1996)).

These non-linear optical materials prepared by utilizing the sol-gel method are promising in the aspect of preventing the relaxation of orientation, but the sol-gel method involves problems peculiar thereto such that the stability of the starting silane compound is generally low, particularly the pot life (a margin of time until gelation proceeds) of the stock solution after the addition of a catalyst into the solution is as short as several minutes to several hours, and thus the working efficiency is low. Further, for example due to contraction of volume at the time of solidifying, fine cracks are apt to occur in the case of the optical material being formed as film or bulk, and thus it has been difficult to obtain a product capable of withstanding use as an optical device.

For example, in Japanese Published Unexamined Patent Application No. Hei 6-235948 there is proposed a method in which an organic non-linear compound is held within a matrix formed using a silane compound by the sol-gel method. According to this method, the occurrence of cracks is prevented by making some improvement as to alkoxysilyl groups contained in the molecule which forms the matrix and also as to the reaction method itself based on the sol-gel method. However, a non-linear optical molecule is merely doped for the material and thus the method in question is not so satisfactory in point of restricting the molecular motion of the non-linear optical molecule, and lowering of an optical coefficient caused by the relaxation of orientation has posed a problem.

Thus, such various problems as mentioned above have involved in the non-linear optical materials prepared by the conventional sol-gel method.

### SUMMARY OF THE INVENTION

In view of the issues noted above the present invention provides, in one aspect thereof, a preparing method of a coating solution for production of a non-linear optical material, the non-linear optical material, a coating solution, and a non-linear optical material using the solution. The processed coating solution is superior in workability at the time of forming the non-linear optical material by a sol-gel method and the non-linear optical material is superior in formability.

The present invention provides, in another aspect thereof, a preparing method of a coating solution for production of a non-linear optical material, the non-linear optical material, and the processed coating solution for producing the non-linear optical material, wherein optimization of a non-linear optical characteristic of the non-linear optical material formed by a sol-gel method and other characteristics than the non-linear optical characteristic is easy and relaxation of orientation of chromophore can be prevented.

More specifically, the present invention resides in a preparing method of a coating solution including the steps of preparing a solution containing at least an organic non-linear molecule having one or more hydrolyzable silicon substituent groups, contacting the solution with a solid catalyst for sufficient time, and separating the solution from the solid catalyst.

### BRIEF DESCRIPTION OF THE DRAWING

Preferred embodiments of the present invention will be described in detail based on the followings, wherein:

FIG. 1 is a schematic diagram illustrating how to evaluate an electro-optical characteristic of a cured film P formed by use of a coating solution according to the present invention.

### DESCRIPTION OF PREFERRED EMBODIMENTS

The present invention will be described in more detail hereunder while broadly classifying it into first embodiment, second embodiment, first and second embodiments, a method for producing a non-linear optical material, and electro-optical devices.

(First Embodiment)

The first embodiment resides in a preparing method of a coating solution and a coating solution for the production of a non-linear optical material, prepared by subjecting a stock solution containing at least an organic non-linear molecule having one or more hydrolyzable silicon substituents to conditioning treatment, wherein the conditioning treatment involves at least a contact step of contacting the stock solution with a solid catalyst and a separating step of separating the stock solution after going through the contact step from the solid catalyst.

There can be obtained a coating solution for the production of a non-linear optical material which coating solution is superior in workability at the time of forming the non-linear optical material by a sol-gel method and which non-linear optical material formed is superior in formability.

The stock solution used in the first embodiment is not specially limited insofar as it contains at least an organic non-linear molecule having one or more hydrolyzable silicon substituent, which molecule may hereinafter be referred to simply as “silicon substituent-containing organic non-linear molecule”. Two or more kinds of silicon substituent-containing organic non-linear molecules may be contained in the stock solution. As to a silicon substituent-containing organic photoconductive molecule, reference will be made thereto later.

The silicon substituent-containing organic non-linear molecule means a molecule which contains an organic group (hereinafter may be referred to as “chromophore”) having a non-linear optical characteristic and further contains one more hydrolyzable silicon substituent (hereinafter may be referred to simply as “silicon substituent”). When a matrix having a desired shape such as film or bulk is formed using the coating solution of the first embodiment, the molecule in question forms a skeletal structure of the matrix and/or bonds to the skeletal structure of the matrix. As to the details of the silicon substituent-containing organic non-linear molecule and the silicon substituent, a description will be given later.

In the stock solution there may be contained one or more kinds of matrix-forming molecules (hereinafter may be referred to as “silicon substituent-containing matrix-forming molecule(s)”) having one or more hydrolyzable silicon substituents and not having a non-linear optical characteristic. Like the silicon substituent-containing organic non-linear molecule, the silicon substituent-containing matrix-forming molecule also forms the skeletal structure of the matrix and/or bonds to the same skeletal structure. As to the details of the silicon substituent-containing matrix-forming molecule, a description will be given later.

In the present invention, “forming the skeletal structure of the matrix” means the formation of two- and/or three-dimensional network structure(s) through covalent bonds. More specifically, it means that each individual molecule as a constituent of the network structure contributes between it and the other molecules which constitute the network structure to the formation of the network structure through two or more covalent bonds.

It is more preferable that the network structure be a three-dimensional network structure.

Since the silicon substituent-containing organic non-linear molecule used in the first embodiment has a skeleton of a crosslinked structure, the motion of its molecular chain is restricted and the relaxation of chromophore orientation is difficult to occur in an ordinary temperature and moisture environment after poling and also in an environment in which the optical material obtained is used as an electro-optical member.

The conditioning treatment is not specially limited insofar as it treats the stock solution through at least a contact step of contacting the stock solution with a solid catalyst and a separating step of separating the stock solution after going through the contact step from the solid catalyst. Other steps may be added before and after and/or simultaneously with those two steps. In the conditioning treatment, however, a catalyst substance substantially incapable of being separated from the stock solution and the coating solution must not be added in an amount of above a spontaneous polymerization proceeding concentration. As to the details of the contact step, separating step, catalyst substance, and spontaneous polymerization proceeding concentration, a description will be given later.

The coating solution in the first embodiment contains substantially no catalyst substance or contains a catalyst substance at a concentration of lower than the spontaneous polymerization proceeding concentration, so that the pot life is very long. Consequently, the workability at the time of forming a non-linear optical material is superior and the formability of the non-linear optical material formed is satisfactory.

In the coating solution of the first embodiment is contained a polymer of a low molecular weight containing at least a silicon substituent-containing organic non-linear molecule. In the polymer of a low molecular weight there may be contained a silicon substituent-containing matrix-forming molecule, a condensable molecule, and an organic photoconductive molecule (simply as “silicon substituent-containing organic photoconductive molecule” hereinafter) having one or more hydrolyzable silicon substituents. As to the silicon substituent-containing organic photoconductive molecule and its function and role, a description will be given later.

In the case where only one or more kinds of silicon substituent-containing organic non-linear molecules are contained in the coating solution out of the silicon substituent-containing organic non-linear molecule and the silicon substituent-containing matrix-forming molecule, at least one of the silicon substituent-containing organic non-linear molecules has a molecular structure capable of forming a skeletal structure of a matrix.

In the case where one or more kinds of silicon substituent-containing organic non-linear molecules and one or more kinds of silicon substituent-containing matrix-forming molecules are contained in the coating solution, one or more molecules, out of the former and latter molecules, have a molecular structure capable of forming a skeletal structure of a matrix. As to such a molecular structure capable of forming a skeletal structure of a matrix, a description will be given later.

In the coating solution there may be incorporated other additives and silicon substituent-containing organic photoconductive molecules as necessary. Such additives will be described later.

(Second Embodiment)

The second embodiment resides in a preparing method and a coating solution for the production of a non-linear optical material, prepared by subjecting a stock solution containing at least a matrix-forming molecule (silicon substituent-containing matrix-forming molecule) having one or more hydrolyzable substituents and also containing an organic non-linear molecule to conditioning treatment involving at least a contact step of contacting the stock solution to a solid catalyst and a separating step of separating the stock solution after going through the contact step from the solid catalyst.

In preparing the stock solution used in the second embodiment, both organic non-linear molecule and silicon substituent-containing matrix-forming molecule may be freely selected and combined as starting materials. Therefore, a non-linear optical characteristic and other characteristics than the non-linear optical characteristic of the non-linear optical material formed by use of the coating solution of the second embodiment can be optimized each independently. To be more specific, the former characteristic can be adjusted to a desired characteristic by selecting a suitable organic non-linear molecule while the latter characteristics can be adjusted to desired characteristics by selecting a suitable silicon substituent-containing matrix-forming molecule.

Thus, it is possible to provide a coating solution which permits easy optimization of the non-linear optical characteristic and other characteristics of the non-linear optical material and which can prevent the relaxation of chromophore orientation.

In the coating solution prepared by conditioning the stock solution there is contained a polymer of a low molecular weight containing at least an organic non-linear molecule and a silicon substituent-containing matrix-forming molecule. In the polymer of a low molecular weight there may be contained such a condensable molecule and a silicon substituent-containing organic photoconductive molecule as mentioned earlier.

The stock solution is not specially limited insofar as it contains a silicon substituent-containing matrix-forming molecule and an organic non-linear molecule. As the silicon substituent-containing matrix-forming molecule there may be used the same silicon substituent-containing matrix forming molecule as that referred to in the first embodiment. In the stock solution used in the second embodiment there may be contained one or more kinds of silicon substituent-containing matrix-forming molecules and one or more kinds of organic non-linear molecules. A silicon substituent-containing organic photoconductive molecule may further be contained therein.

The organic non-linear molecule is not specially limited insofar as it can form and/or bond to a skeletal structure of a matrix, as noted earlier. It is preferable that the organic non-linear molecule have one or more hydrolyzable silicon substituents. As such an organic non-linear molecule there may be used the same molecule as the silicon substituent-containing organic non-linear molecule used in the first embodiment.

The conditioning treatment in the second embodiment, like that in the first embodiment, treats the stock solution through at least a contact step of contacting the stock solution with a solid catalyst and a separating step of separating the stock solution after going through the contact step from the solid catalyst. Other steps may be added before and after and/or simultaneously with those two steps.

It is preferable that a substance which acts to polymerize at least molecules each having a silicon substituent-containing substance with each other not be added into the stock solution before being treated by the conditioning treatment. Further, in the conditioning treatment, it is preferable that a catalyst substance substantially incapable of being separated from the stock solution and the coating solution having gone through the conditioning treatment not be added in an amount of above the spontaneous polymerization proceeding concentration before the conditioning treatment.

Thus, the coating solution which has gone through the above conditioning treatment has a long pot life and therefore, like the coating solution of the first embodiment, is superior in workability at the time of forming a non-linear optical material by the sol-gel method, and the formability of the non-linear optical material formed is satisfactory.

In connection with the organic non-linear molecule and the silicon substituent-containing matrix-forming molecule both contained in the stock solution, if one or more kinds of organic non-linear molecules and one or more kinds of silicon substituent-containing matrix-forming molecules are contained in the stock solution, at least one kind of molecule out of the former and latter molecules has a molecular structure capable of forming a skeletal structure of a matrix. Such a molecular structure will be described later.

Other additives and silicon substituent-containing organic photoconductive molecules may be incorporated as necessary into the coating solution. Such additives will be described later.

Main contents common to both first and second embodiments described above will be referred to below successively in a broadly classified state as follows: organic non-linear molecule and chromophore, silicon substituent-containing organic non-linear molecule, silicon substituent-containing matrix-forming molecule, silicon substituent-containing organic photoconductive molecule, hydrolyzable silicon substituent, contact step (solid catalyst) and separating step, other components in the coating solution, and solvents used in the stock solution and the coating solution.

<Organic Non-Linear Molecule and Chromophore>

As the organic non-linear molecule used in the present invention there may be used a known organic non-linear compound.

Alternatively, a derivative capable of forming and/or covalently bonding to a skeletal structure of a matrix may be introduced into a part of a known organic non-linear compound. As examples thereof, mention may be made of the silicon substituent-containing organic non-linear molecules referred to above, but this point will be described later.

The chromophore structure used in the present invention is not specially limited insofar as it is a known one, but those represented by the following structural formula (1) are preferred:

D-P-A (1)

where D stands for an atomic group having an electron donating property, P stands for a bond moiety, and A stands for an atomic group having an electron attracting property.

In the structural formula (1), as the electron donating atomic group represented by D there may be used a known one if it possesses an electron donating property, but preferably it is an aliphatic unsaturated bond, an aromatic ring, or a hetero-aromatic ring, having an electron donating group, or a combination thereof.

The electron donating substituent group is not specially limited as long as it possesses an electron donating property, bur preferred examples thereof are alkyl, alkoxy, and amino groups. The alkyl may be partially substituted by alkoxy or phenyl. Likewise, the alkoxy may be partially substituted by alkoxy or phenyl, and the amino group may be partially substituted by alkyl, alkoxy, or phenyl.

As the electron attracting atomic group represented by A there may be used any known one as long as it possesses an electron attracting property, but preferably it is an aliphatic unsaturated bond, an aromatic ring, or a hetero-aromatic ring, with an electron attracting substituent introduced therein, or a combination thereof.

Preferred examples of the electron attracting substituent group are halogen atom, halogen-substituted alkyl, cyano, nitro, and carbonyl.

The bond moiety represented by P is not specially limited as long as it is a covalent bond to bond D and A with each other, but preferably it possesses a conjugated bond which can unlocalize electrons. For example, one having such a structure as joins D and A in a π conjugated system is preferred. More specifically, an aliphatic unsaturated bond, an aromatic ring, a hetero-aromatic ring, or an interlinkage thereof, is preferred.

As examples of the structural formula (1) are mentioned Disperse Reds and Disperse Oranges represented by the following formulas (1-1) to (1-4), stilbene compounds represented by the following formulae (1-5) to (1-11), and compounds having the structures represented by the following formulas (1-12) to (1-17). In the following formula (1-16), “Bu” stands for butyl and “Me” stands for methyl.

| 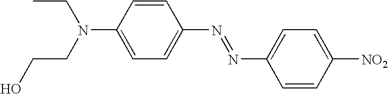 | 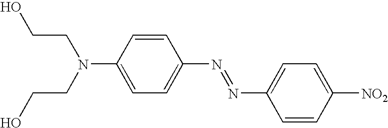 |
|---|---|
| (1-1) | (1-2) |
| 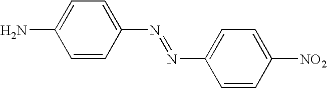 | 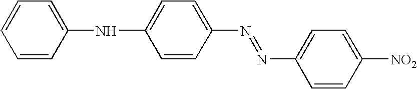 |
| (1-3) | (1-4) |
| 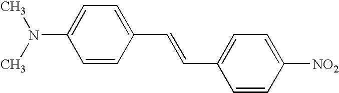 | 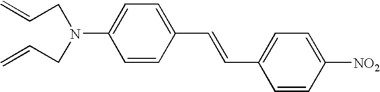 |
| (1-5) | (1-6) |
| 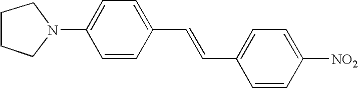 | 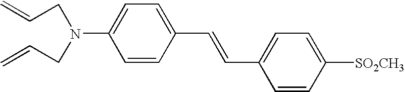 |
| (1-7) | (1-8) |
| 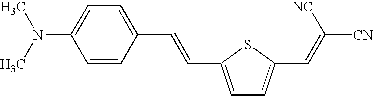 | 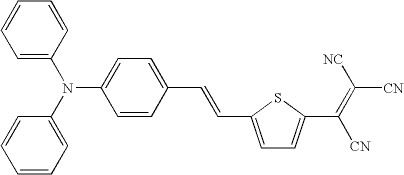 |
| (1-9) | (1-10) |
| 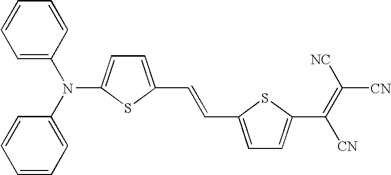 | |
| (1-11) | |
| 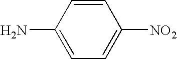 | 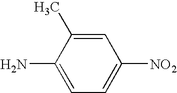 |
| (1-12) | (1-13) |
| 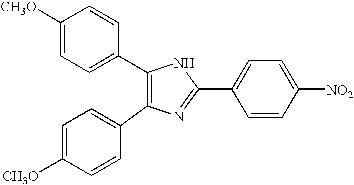 | 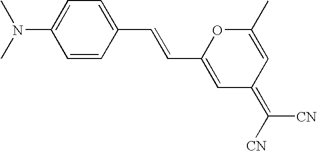 |
| (1-14) | (1-15) |

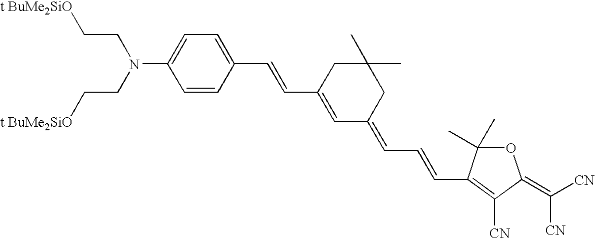

(1-16)

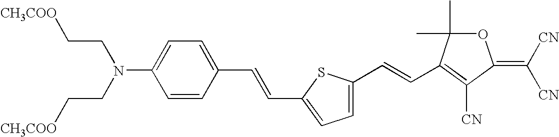

(1-17)

<Silicon Substituent-Containing Organic Non-Linear Molecule>

The silicon substituent-containing organic non-linear molecule used in the present invention is represented by the following structural formula (2):

G(—Y)ⱼ (2)

where G stands for an organic group having a non-linear optical characteristic, Y stands for a hydrolyzable silicon substituent, and j stands for an integer of 1 or larger.

The structure represented by G in the structural formula (2) corresponds to a such a structure as a valence for bonding to Y having been introduced in any site of the foregoing structural formula (1), i.e., D-P-A.

The valence is not specially limited as long as it can join G and Y. Examples include divalent hydrocarbon groups represented by —CₙH₂ₙ—, CₙH₂ₙ₋₂—, and —CₙH₂ₙ₋₄—, where n stands for an integer of 1 to 15, —COO—, —S—, —O—, —N═CH—, divalent benzene rings, as well as those compounds with substituent groups introduced therein or combinations thereof. The valence may be introduced into any site of D-P-A, the structural formula (1), but it is preferable to select the introducing site and the structure of valence so as not to impair the non-linear optical characteristic.

The hydrolyzable silicon substituent Y in the structural formula (2) is represented by the following formula (2′). As to concrete examples of the hydrolyzable silicon substituent, a description will be given later:

—Si(R¹)ₘ(Q¹)₃₋ₘ (2′)

where R¹ stands for hydrogen, alkyl, or substituted or unsubstituted aryl, Q¹ stands for a hydrolyzable substituent group, and m is an integer of 0 to 2.

In the structural formula (2), Y may be bonded to any site of G through a valence, but for suppressing the relaxation of chromophore orientation it is preferable that Y be bonded to an end of the molecular chain irrespective of whether the molecular chain which constitutes G is straight-chained or branched. Further, for suppressing the molecular vibration in the matrix to suppress the orientation relaxation of chromophore more effectively and securely, it is preferable that Y be joined to or near an end of the molecular chain and that j be 2 or more.

In the case where the silicon substituent-containing non-linear molecule can form a skeletal structure of a matrix at least as a simple substance, it is preferable that the number, j, of silicon substituents in the structural formula (2) be 2 or larger. An upper limit of the number j is not specially limited, but is preferably 4. If the number j exceeds 4, the matrix formed will be deficient in flexibility, which may bring the result that cracks are apt to occur or poling treatment becomes infeasible.

As examples of the structural formula (2) are mentioned those represented by the following formulas (2-1) to (2-8), in which Me stands for methyl and Et stands for ethyl:

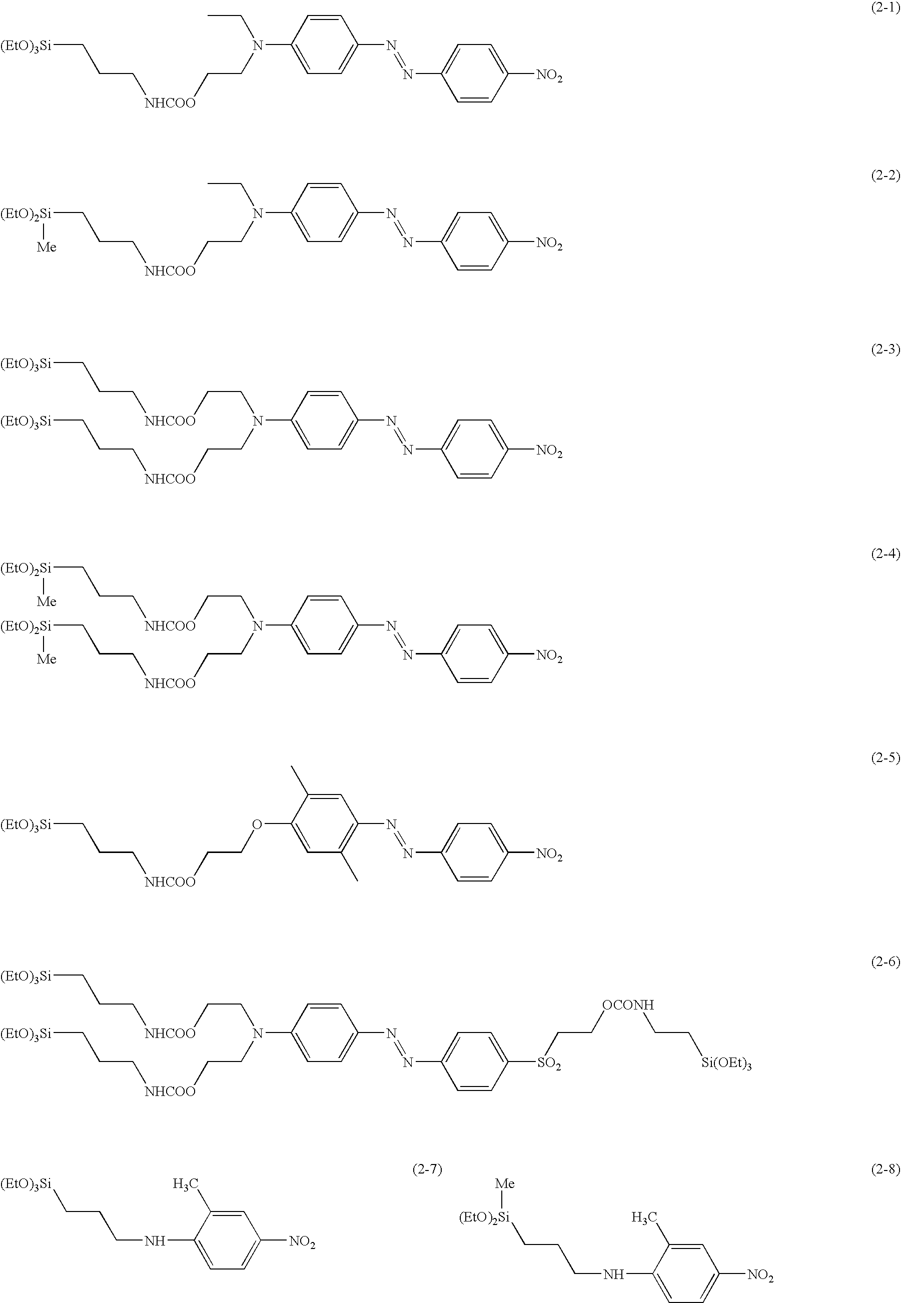

<Silicon Substituent-Containing Matrix-Forming Molecule>

The silicon substituent-containing molecule used in the present invention is represented by the following structural formula (3):

T(—X)ᵢ (3)

where T stands for a hydrocarbon group represented by —CₙH₂ₙ—, —CₙH₂ₙ₋₂—, or —CₙH₂ₙ₋₄—, which may be branched and wherein n is an integer of 1 to 15, —S—, —O—, —O—(Si—O)ₙ— (n is an integer of 1 to 15), an arylene group (C₁₋₂₀) which may be substituted by C₁₋₁₅ alkyl or alkoxy, or a combination thereof, X stands for a hydrolyzable silicon substituent, and i is an integer of 1 or larger.

The hydrolyzable silicon substituent X in the structural formula (3) is represented by the following structural formula (3′), which is substantially the same as the foregoing structural formula (2′):

—Si(R²)ₙ(Q²)₃₋ₙ (3′)

where R² stands for hydrogen, an alkyl group, or a substituted or unsubstituted aryl group, Q² stands for a hydrolyzable substituent group, and n is an integer of 0 to 2.

The structure represented by T in the structural formula (3) imparts moderate flexibility to the silicon substituent-containing matrix forming molecule, thus giving rise to the effect that a strain induced at the time of forming a matrix with use of the coating solution of the invention is absorbed to prevent the occurrence of cracks, whereby the uniformity of the matrix formed can be further improved.

Therefore, in the case of forming a filmy non-linear optical material, it is possible to form a thicker film without the occurrence of cracks, and in the case of forming a bulk-like non-linear optical material, it is possible to form a larger bulk without cracking. In addition, since the matrix is highly uniform, it is possible to apply the material to an optical device which is fabricated using a non-linear optical material having higher uniformity. Further, the foregoing flexibility also gives rise to the effect that the chromophore structure in the matrix becomes easier to move in poling treatment.

The aforementioned effects can be obtained even in the case where the number of the silicon substituent contained in the silicon substituent-containing matrix-forming molecule is one. However, in the case of a silicon substituent-containing matrix-forming molecule having one silicon substituent and having a relatively long molecular chain structure, there sometimes occurs a case where the reaction of forming a skeletal structure of a matrix is difficult to proceed or a case where there arises the problem that the thermal stability of the matrix is deteriorated.

To avoid the occurrence of such problems, it is preferable for the silicon substituent-containing matrix-forming molecule to contain two or more silicon substituent groups. Preferred examples of such a silicon substituent-containing matrix-forming molecule are those represented by the following formulas (3-1) to (3-17), in which Me stands for methyl, Et stands for ethyl, and Pr stands for propyl:

| 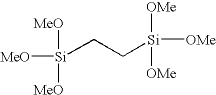 | 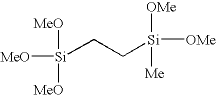 |
|---|---|
| (3-1) | (3-2) |
| 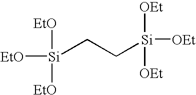 | 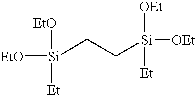 |
| (3-3) | (3-4) |
| 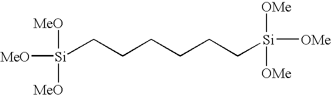 | 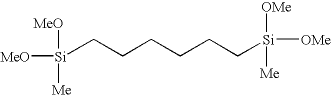 |
| (3-5) | (3-6) |
| 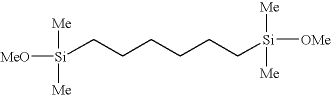 | 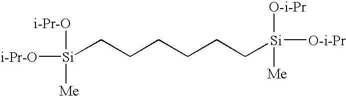 |
| (3-7) | (3-8) |
| 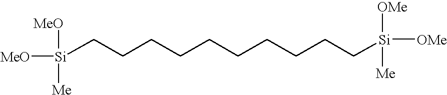 | 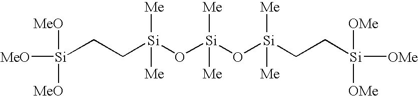 |
| (3-9) | (3-10) |
| 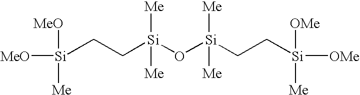 | 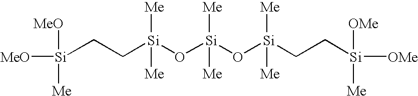 |
| (3-11) | (3-12) |
| 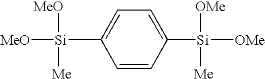 | 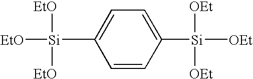 |
| (3-13) | (3-14) |
| 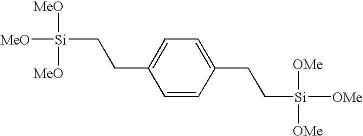 | 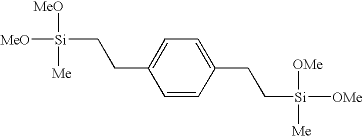 |
| (3-15) | (3-16) |
| 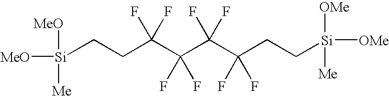 | |
| (3-17) | |

An upper limit of the number, i, of silicon substituents is not specially limited, but is preferably 4. If the number i exceeds 4, the matrix formed will be deficient in flexibility, which may bring the result that cracks are apt to occur or poling becomes infeasible.

Examples of the structural formula (2) are not limited to those represented by the formulas (3-1) to (3-17), and there may be used any of known matrix-formable compounds used in the sol-gel method. Examples are tetramethoxysilane, tetraethoxysilane, methyltrimethoxysilane, dimethyldimethoxysilane, vinyltrichlorosilane, vinyltrimethoxysilane, vinyltriethoxysilane,

γ-glycidoxypropylmethyldiethoxysilane,

γ-glycidoxypropyltrimethoxysilane,

γ-aminopropyltriethoxysilane,

γ-aminopropyltrimethoxysilane,

γ-aminopropylmethyldimethoxysilane, and N-β(aminoethyl) γ-aminopropyltriethoxysilane.

<Silicon Substituent-Containing Organic Photoconductive Molecule>

The silicon substituent-containing organic photoconductive molecule used in the present invention is for imparting a photorefractive characteristic to the non-linear optical material prepared by use of the coating solution of the present invention.

The photorefractive characteristic is developed by a combination of a secondary non-linear optical characteristic and photoconductivity. It is necessary that a silicon substituent-containing organic photoconductive molecule represented by the following structural formula (4) be contained in the stock solution used in the present invention as described above or in the coating solution of the present invention:

C(—Z)ₖ (4)

where C stands for a photoconductive organic group, Z stands for a hydrolyzable silicon substituent, and k is an integer of 1 or larger.

In the above structural formula (4), C corresponds to a known photoconductive organic compound with a valence for bonding to Z introduced therein.

The structure represented by C is not specially limited and there may be used a known one as long as it is an organic group which exhibits photoconductivity. Examples are carbazole, hydrazone, phthalocyanine, porphyrin, azo, squarylium, anthoanthrone, and perylene compounds.

The valence is not specially limited insofar as it can join C and Z, but as examples thereof mention may be made of those already referred to above. The valence may be introduced into any site of C, but it is preferable that a suitable site for introduction and a structure of the valence be selected so as not to impair the photoconductivity.

The hydrolyzable silicon substituent Z in the structural formula (4) is represented by the following structural formula (4′), which is substantially the same as the foregoing structural formula (2′):

—Si(R³)ₗ(Q³)₃₋₁ (4′)

where R³ stands for hydrogen, an alkyl group, or a substituted or unsubstituted aryl group, Q³ stand for a hydrolyzable substituent group, and l is an integer of 0 to 2.

As examples of the structural formula (4) are mentioned those represented by the following formula (4-1), in which Et stands for ethyl:

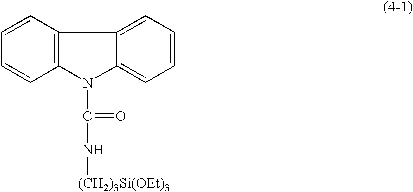

<Hydrolyzable Silicon Substituent>

As to the hydrolyzable substituents (Q¹, Q², and Q³; simply as “Q” hereinafter) in the above structural formulas (2′), (3′), and (4′), no special limitation is imposed thereon as long as they are hydrolyzable, but as examples mention may be made of hydroxy, alkoxy, methyl ethyl ketoxime, diethylamino, acetoxy, propenoxy, and halogen, with hydroxy and alkoxy being preferred.

From the viewpoint of forming a skeletal structure of a matrix having such characteristics as being difficult to be cracked, being flexible and easy to undergo poling treatment, it is preferable that the silicon substituent group lie at or near an end of the molecular chain. Moreover, it is preferable that silicon substituent groups be present at two or more sites in each of the structures represented by the structural formulas (2), (3), and (4).

The structure (simply as “R” hereinafter) represented by R¹, R², and R³ in the silicon substituent group means hydrogen, an alkyl group, or a substituted or unsubstituted aryl group. The alkyl group is not specially limited, but is preferably one having 1 to 20 carbon atoms, more preferably one having 1 to 15 carbon atoms. As the aryl group, one having not more than three aromatic rings is preferred.

It is optional whether the aryl group has or does not have a condensed ring structure. Both may be mixed together. By selecting a suitable structure represented by R which is introduced into the silicon substituent group and a suitable number to be introduced, it is possible to adjust the hardness and flexibility of the matrix.

As noted earlier, the number of hydrolyzable substituent group Q which one silicon substituent group possesses is 1 to 3. However, if the number of Q is three, the silicon substituent group tends to become more reactive, with consequent deterioration in stability of the coating solution and shortening of the pot life until gelation proceeds by the low-molecular polymer contained in the coating solution.

In such a case, by setting the number of the hydrolyzable substituent group Q in the silicon substituent to two and by instead introducing such a structure R as shown above to suppress the reactivity, it is possible to improve the pot life.

In the case where the hydrolyzable substituent group Q is alkoxy, the above reactivity decreases in the order of methoxy>ethoxy>propoxy. For example, therefore, if isopropoxy is substituted for ethoxy, the pot life can be further improved.

<Contact Step (Solid Catalyst) and Separating Step>

The following description is now provided about the solid catalyst used in the conditioning treatment which is performed in preparing the coating solution of the present invention, and also about the method and procedure for separating the solid catalyst from the stock solution which has been treated with the solid catalyst. The solid catalyst is not specially limited insofar as it is insoluble in water used in the stock solution or in a mixed solvent of water and a hydrophilic solvent and insofar as it hydrolyzes the silicon substituent-containing molecule to form silanol.

If the solid catalyst is not used, the workability in forming the non-linear optical material and/or the formability of the non-linear optical material may be deteriorated.

As known heretofore, in the case of preparing the coating solution by the sol-gel method, there has been used an easily dissolving catalyst (simply as “homogeneous catalyst” hereinafter), for example, any of such inorganic and organic acid catalysts as hydrochloric acid and acetic acid. In the present invention, substances exhibiting such a catalytic action are generically termed “catalyst substance.”

The method using such a homogeneous catalyst is convenient, but the homogeneous catalyst added into the stock solution cannot be separated, so in the coating solution prepared by use of the homogeneous catalyst, a gelation reaction proceeds in a relatively short time and it is impossible to substantially stop the gelation reaction. Consequently, it is difficult to form a matrix (film or bulk) having a desired shape.

For example, in the case of forming a film on a substrate, it is necessary that a coating solution which is in an appropriate state, namely, in a somewhat proceeded state of hydrolysis and polymerization reaction, be used and applied quickly onto the substrate. If an appropriate reaction time is exceeded, the coating solution will gel or aggregate rapidly, which may bring the result that a film having a thickness larger than necessary is obtained, or gelation proceeds too much and the coating solution is no longer applicable to the substrate, or a film, even if formed, is badly influenced in its uniformity and physical properties.

Conversely, if the application of the coating solution is performed earlier than the appropriate reaction time, the reaction for forming a skeletal structure of a matrix may become difficult to proceed due to insufficient hydrolysis of the silicon substituent group or the thickness of the film formed may be too small because of the excessively low viscosity of the coating solution.

That is, since not only the pot life of the coating solution is short but also gelation proceeds with the lapse of time, the timing for application of the coating solution to form a film is limited, and the workability is low because it is difficult to grasp such a timing quantitatively. Further, due to such a poor workability, the formability of forming a film having a desired thickness by single coating without cracking and the formability of forming a bulk having a desired size by single casting without cracking (the former will hereinafter be referred to as “film formability” and the latter as “bulk formability”) are also poor.

Therefore, the solid catalyst used in the present invention, which can avoid the abovementioned problems, is not specially limited as long as it satisfies the foregoing conditions, but mention may be made of the following as concrete examples thereof. The following may be used each alone or in a combination.

In the case of using a cation-exchange resin as the solid catalyst, examples include Amberlite 15, Amberlite 200C, Amberlyst 15, Amberlyst 15E (all are products of Rohm & Haas Co.), DOWEX MWC-1-H, DOWEX 88, DOWEX HCR-W2 (all are products of Dow Chemical Co.), Lewatit SPC-108, Lewatit SPC-118 (both are products of Bayer A. G.), DIAION RCP-150H (a product of Mitsubishi Kasei Corp.), Sumikaion K-470, Duolite C26-C, Duolite C-433, Duolite 464 (all are products of Sumitomo Chemical Co., Ltd.), Nafion-H (a product of Du Pont), and Purolite (a product of AMP Ionex Corp.).

In the case of using a cation-exchange resin as the solid catalyst, examples include Amberlite IRA-400 and Amberlite IRA-45 (both are products of Rohm & Haas Co.). In the case of using an inorganic solid substance with a proton acid radical bonded to the surface thereof, examples include Zr(O₃PCH₂CH₂SO₃H)₂ and Th(O₃PCH₂CH₂COOH)₂. In the case of using a polyorganosiloxane containing a proton acid radical, examples include polyorganosiloxanes containing a sulfonic acid radical.

In the case of using a heteropolyacid, examples include cobalt-tungstic acid and phosphorus-molybdic acid. In the case of using an isopolyacid, examples include niobic acid, tantalic acid, and molybdic acid. In the case of using a unitary metal oxide, examples include silica gel, alumina, chromia, zirconia, CaO, and MgO. In the case of using a composite metal oxide, examples include silica-alumina, silica-magnesia, silica-zirconia, and zeolites. In the case of using a clay mineral, examples include acid clay, activated clay, montmorillonite, and kaolinite.

In the case of using a metal phosphate, examples include zirconia phosphate and lanthanum phosphate. In the case of using an inorganic solid substance with an amino group-containing group bonded to the surface thereof, mention may be made, as an example, of a solid substance obtained by the reaction of aminopropyltriethoxysilane on silica gel. In the case of using an amino group-containing polyorganosiloxane, examples include amino-modified silicone resins.

For preparing a coating solution from the stock solution with use of the solid catalyst exemplified above, it is necessary for the stock solution to go through at least a contact step of contacting the stock solution with the solid catalyst and a separating step of separating the stock solution after going through the contact step from the solid catalyst.

The contact step is not specially limited insofar as at least the stock solution and the solid catalyst can contact each other for a certain period, allowing hydrolysis to take place. The kind, amount and shape of the solid catalyst used are selected according to conditions (temperature, etc.) for the contact treatment established so as to afford desired film or bulk formability and also according to the silicon constituent-containing matrix-forming molecule and/or silicon substituent-containing organic non-linear molecule contained in the stock solution. The separating step is not specially limited insofar as the stock solution which has been treated with the solid catalyst and the solid catalyst are separated from each other spatially completely.

The contact and separation between the stock solution and the solid catalyst in such a contact step and a separating step can be done in a continuous manner, for example, by passing the stock solution through a porous or fibrous carrier with the solid catalyst supported thereon. Alternatively, such contact and separation can be done batchwise, for example, by dispersing the solid catalyst in the stock solution, allowing a catalytic reaction to take place, and subsequent atmospheric, vacuum, or pressure filtration using any of various filters such as filter paper, membrane filter, glass filter, and cotton filter, or by pouring the stock solution into a reaction vessel with the solid catalyst applied to an inner wall surface thereof, allowing the stock solution to stand for a certain period under stirring, and subsequent transfer of the stock solution into another vessel.

The amount of the solid catalyst used is not specially limited, but is preferably within the range of 0.001 to 20 mass %, more preferably 0.01 to 10 mass %, relative to the total amount of the silicon substituent-containing components contained in the stock solution.

The temperature for contact and reaction of the stock solution with the solid catalyst differs depending on the kind of the solid catalyst used and of the components contained in the stock solution, but is preferably in the range of 0° C. to 100° C., more preferably 5° C. to 70° C., particularly preferably 10° C. to 50° C.

As to the reaction temperature, no limitation is placed thereon, but is preferably in the range of 10 minutes to 100 hours because a longer reaction time permits easy gelation. The reaction time is determined taking into account other characteristics and physical properties than the non-linear optical characteristic of the matrix such as, for example, physical properties and characteristics of a film other than the non-linear optical characteristic, such as thickness and hardness of the film in the case of forming the film on a substrate.

The stock solution having thus gone through the contact step and the separating step may be used as it is as a coating solution, but it is desirable that other constituent materials (such as the foregoing organic non-liner molecule and silicon substituent-containing matrix-forming molecule, and silicon substituent-containing organic conductive molecule), a hydrophilic solvent, a curing agent, and other additives be added as necessary into the stock solution to prepare a coating solution. As to the details of the curing agent and other additives, a description will be given later.

By optimizing the kind and amount of the curing agent to be added into the stock solution having gone through the separating step or by adding a suitable stabilizer, it is possible to keep low the progress of gelation of the coating solution at a room temperature. For example, by selecting and adding a suitable thermoreactive catalyst and a suitable stabilizer, it becomes possible to maintain the coating solution stably at a room temperature over a long period of time.

As noted above, in case of adding other components into the stock solution after leaving the separating step to afford the coating solution, the other components may be added just after the separating step, but it is also effective to allow the stock solution to stand for one hour or longer after leaving the separating step. If a matrix is formed using the coating solution obtained after thus allowing the stock solution to stand, it may be possible to further improve other characteristics and physical properties the than non-linear optical characteristic, e.g., curing property, of the matrix. Such a standing time is preferably 10 minutes to 250 hours, more preferably 2 to 200 hours.

The coating solution thus having been subjected to the conditioning treatment is stable unless there is added a catalyst that causes polymerization and gelation to proceed at a room temperature such as a homogeneous catalyst or the solid catalyst used in the present invention. In this state, therefore, it is possible to prepare and store the coating solution in a large amount. Further, it is possible to take out only a required amount when necessary, then add a catalyst and other components into the solution and use the solution for coating.

<Other Components in the Coating Solution>

The foregoing curing catalyst and other additives will now be described in more detail. The curing agent added into the coating solution of the present invention is for accelerating the curing of a matrix after forming the matrix such as film or bulk using the coating solution. From the viewpoint of ensuring the controllability for the matrix curing process, it is preferable to use a curing agent which cures upon exposure to an external energy such as heat or light.

As examples of such a curing agent there are mentioned a thermosetting catalyst and a photosetting catalyst. The thermosetting catalyst means a catalyst which on heating accelerates the formation of bonds between molecular chains in the matrix. The photosetting catalyst means a catalyst which upon exposure to light such as ultraviolet rays accelerates the formation of bonds between molecular chains in the matrix.

As examples of the curing agent are mentioned protic acids such as hydrochloric acid, acetic acid, phosphoric acid, and sulfuric acid, bases such as ammonia and triethylamine, organotin compounds such as dibutyltin diacetate and dibutyltin dioctoate, organotitanium compounds such as tetra-n-butyl titanate and tetraisopropyl titanate, organoaluminum compounds such as aluminum tributoxide and aluminum triacetylacetonate, and iron salts, managanese salts, cobalt salts, zinc salts, and zirconium salts of organic carboxylic acids.

Above all, metallic compounds are preferred from the viewpoint of storage stability of the coating solution.

Acetylacetonate and acetylacetate of metal are more preferred. In this case, a further addition of acetylacetone may improve the storage stability of the coating solution.

In the above curing agent there also is contained the same substance as in the homogeneous catalyst referred to previously such as a protic acid, e.g., hydrochloric acid, acetic acid, phosphoric acid, or sulfuric acid. When such a catalytic substance as in the curing agent is added as an additive into the coating solution, it is preferable to avoid the addition thereof in an amount of above the spontaneous polymerization proceeding concentration. Otherwise, the pot life of the coating solution will become shorter, with may result in deterioration of workability and formability.

The term “spontaneous polymerization proceeding concentration” means a lower-limit value of an addition concentration at which, during storage of the coating solution containing a catalytic substance like the abovementioned curing agent in an ordinary temperature and humidity environment, the coating solution becomes unemployable because of gelation proceeding in a shorter time than a desired pot life.

For ensuring satisfactory workability and formability, though depending on the desired pot life and the catalytic substance added, it is preferable that the spontaneous polymerization proceeding concentration be selected so as to give a pot life of at least eight hours, preferably 24 hours or longer.

Thus, the amount of the curing agent added is not specially limited, but in point of the pot life and storage stability of the coating solution and the strength of a matrix, the amount of the curing agent added is preferably in the range of 0.1 to 20 mass %, more preferably 0.3 to 10 mass %, based on the total amount of silicon substituent-containing components contained in the stock solution.

Next, a description will now be given of other additives which may be added into the coating solution of the present invention. Such other additives are not specially limited as long as they do not deteriorate desired characteristics such as storage stability of the coating solution, formability at the time of forming a matrix using the coating solution and non-linear optical characteristic of the matrix obtained. For example, however, for the purpose of adjusting the formability and plasticity of the resulting filmy or bulk-like matrix or for imparting water-repellency to the matrix, there may be used commercially available various additives, including silicon-based hard coating agents and fluorine compounds.

As examples of commercially available hard coating agents are mentioned KP-85, X-40-9740, and X-40-2239 (all are products of Shinetsu Silicone Co.), and AY42-440, AY42-441, and AY49-208 (all are products of Toray Dow Corning Co.).

As examples of fluorine compounds are mentioned (tridecafluoro-1,1,2,2-tetrahydrooctyl) triethoxysilane, (3,3,3-trifluoropropyl) trimethoxysilane, 3-(heptafluoroisopropoxy) propyltriethoxysilane, 1H, 1H, 2H, 2H-perfluoroalkyltriethoxysilane, 1H, 1H, 2H, 2H-perfluorodecyltriethoxysilane and 1H, 1H, 2H, 2H-perfluorooctyltriethoxysilane. It is preferable that the amount of a fluorine compound added be not more than 0.25 mass % based on the total fluorine-free components except solvent in the coating solution. If the amount in question exceeds 0.25 mass %, there may occur a problem with the formability of a matrix.

<Solvents Used in the Stock Solution and the Coating Solution>

One or more solvents may be used in the stock solution and the coating solution. Examples of employable solvents include alcohols (e.g., methanol, ethanol, propanol, butanol), ketones (e.g., acetone, methyl ethyl ketone), and ethers (e.g., tetrahydrofuran, diethyl ether, dioxane). Preferred solvents are those boiling at not higher than 150° C. The stock solution may be a phase-separated solution. But in this case, it is preferable for the coating solution to become a homogeneous solution when made into a coating solution with the progress of hydrolysis.

The amount of the catalyst contained in the stock solution and the coating solution is not specially limited, but the amount of the catalyst is preferably in the range of 0.5 to 30 parts by mass, more preferably 1 to 20 parts by mass, relative to 1 part by mass of a constituting component in the stock solution because a solid matter becomes easy to deposit if the amount is too small.

The amount of water contained in the stock solution is not specially limited, but for ensuring the storage stability of the coating solution prepared by conditioning the stock solution and for suppressing excessive polymerization in the conditioning treatment and suppressing the progress of gelation, the amount of water is preferably in the range of 30% to 500%, more preferably 50% to 300%, relative to a theoretical amount required for hydrolyzing all of the hydrolyzable substituent groups in the silicon substituent-containing components contained in the stock solution.

If the amount of water is larger than 500%, the storage stability of the coating solution may be deteriorated or solid components may become easier to deposit. When the amount of water exceeds 500%, the mixing of alcohols in water may be preferred for preventing such deterioration of storage stability.

On the other hand, when the amount of water is smaller than 30%, the proportion of unreacted silicon substituent-containing components increases, so that when a matrix such as film or bulk is formed using the coating solution or when the matrix is cured, the matrix is apt to undergo phase separation or lowering of strength. There is sometimes a case where the mixing of alcohols is preferred for the improvement of storage stability.

(How to Prepare Non-Linear Optical Material)

The following description is now provided about how to prepare the non-linear optical material using the coating solution of the present invention.

How to prepare the non-linear optical material according to the present invention is not specially limited insofar as it is prepared using the coating solution of the present invention. For example, by pouring the coating solution into a mold, followed by curing, there can be formed a non-linear optical material constituted of a bulk-like matrix, or by applying and curing the coating solution on a substrate such as a base plate or fibers having a desired shape there can be formed a non-linear optical material constituted of a filmy matrix.

How to prepare the non-linear optical material will be described below on the premise that the coating solution is applied onto a base plate.

How to apply the coating solution is not specially limited. There may be adopted a known method such as spin coating, spray coating, blade coating, or dip coating.

Curing treatment is conducted after the coating solution is applied onto a base plate. The curing treatment may be carried out by natural drying to remove the solvent used and allowing cure to proceed naturally.

But the curing treatment may involve the utilization of vacuum drying to remove the solvent used or may involve heating or ultraviolet radiation while utilizing a curing agent pre-added into the coating solution.

For imparting an electro-optical characteristic to the non-linear optical material, poling treatment should be performed as necessary at the same time as the curing treatment. But such poling treatment may be omitted in the case of imparting only a photorefractive characteristic to the non-linear optical material.

Both solvent removal and curing treatment may be carried out simultaneously under heating, or the removal of solvent by vacuum drying may be followed by curing treatment under heating. In the case of performing the poling treatment, it may be performed after the curing treatment, but the simultaneous execution with the curing treatment is more preferred. For example, a preferred method involves removing the solvent by vacuum drying at a room temperature, conducting the curing treatment under heating while allowing the poling treatment to proceed by the application of an electric field, subsequent reducing the temperature to room temperature under the application of an electric field, and removal of the electric field.

It is also preferable that the poling treatment be carried out by heating under the application of voltage after preliminary curing treatment has been allowed to proceed to a certain extent not reaching complete curing. The temperature of such preliminary curing treatment may be the same as or a little lower than the temperature of the poling treatment which is subsequently carried out.

In the present invention, as the matrix curing reaction proceeds by heating, Tg (glass transition point) of the matrix increases and the chromophore becomes difficult to move in its oriented state even at a high temperature. Therefore, the operation of reducing the temperature to room temperature under the application of an electric field after poling is not always necessary.

In the case where both curing treatment and poling treatment are conducted at a time under heating, the temperature may be raised at a stretch to the curing reaction temperature under the application of an electric field, but by so doing the curing reaction will proceed before orientation and therefore the chromophore becomes difficult to move, which may bring the result that it is not possible to carry out the orienting treatment effectively.

In the above case, it is effective to adopt a method wherein the temperature is increased gradually and continuously in a voltage-applied state or a method wherein the temperature is raised stepwise. That is, if the curing reaction proceeds at a certain temperature, Tg rises and orientation becomes difficult to occur. Then, if the temperature is raised a little to a higher level than Ta at that time, it becomes possible for the chromophore to move and orientation again proceeds. It is presumed that the entire orientation can be allowed to proceed by repeating these operations.

The voltage applied in poling may be constant or may be changed stepwise. At this time, a periodically changing voltage may be superimposed on that voltage.

For the application of an electric field in poling there may be adopted a known method. For example, there may be adopted a corona discharge method using needle-, rod- or plate-like arc electrodes, wire electrodes, or a combination thereof, or an electrode method wherein a film formed on a base plate is sandwiched directly in between electrodes.

In the electrode method, electrodes may be formed directly on the film, or electrodes may be approximated to or contacted with the film only at the time of poling. As the material of electrodes formed directly on film there may be used, for example, any of various metals, including gold, aluminum, nickel, chromium, and palladium, as well as alloys and oxides thereof.

As the method for forming electrodes directly on film there may be adopted the conventional vapor deposition or sputtering method. As the electrodes to be approximated to or contacted with film there may be used the same electrodes as above or electrodes obtained by forming a conductive film on a non-conductive substrate such as glass or a plastic material.

The poling treatment may be conducted in the air, but may also be conducted in an inert gas atmosphere such as nitrogen or argon or under a reduced pressure. By conducting the poling treatment in such an environment, it may be possible to prevent deterioration caused by oxygen contained in air or by a discharge product. There also accrues an effect of preventing arc discharge which occurs in direct application of voltage in the electrode method.

(Electro-Optical Device)

The non-linear optical material of the present invention prepared in the manner described above can be applied to any of devices which utilize the non-linear optical characteristic. For example, it is also applicable to a wavelength transformer. Further, the non-linear optical material may be used as a constituent material of a device by utilizing other characteristics than the non-linear optical characteristic, like the core layer in an optical waveguide. Particularly, as an application example taking device into account, reference will now be made to an electro-optical device which utilizes an electro-optical characteristic. Such an electro-optical device is preferably utilized as a device having a structure in which the non-linear optical material is formed on a base plate and is sandwiched in between a pair of electrodes for input signal.

As the material which constitutes such a base plate there may be used, for example, any of such metals as aluminum, gold, iron, nickel, chromium, and stainless steel, semiconductors such as silicon, titanium oxide, zinc oxide, and gallium arsenide, glass, and plastics such as PET (polyethylene terephthalate), polycarbonate, polyester, polyvinyl, polyvinyl chloride, polyvinyl acetate, polymethyl acrylate, plymethyl methacrylate, polyurethane, polyimide, polyphenyl, polystyrene, and polyamide.

On the surface of a base plate constituted by a non-conductive material out of the materials exemplified above there may be formed a conductive film as one electrode. As the material of the conductive film there may be used, for example, any of various metals, various oxides such as NESA (tin oxide), indium oxide, and ITO (composite tin oxide-indium oxide), and various organic conductors such as polythiophene, polyaniline, polyparaphenylene vinylene, and polyacetylene. The conductive film is formed by a known vapor-phase coating method such as vapor deposition or sputtering or a liquid-phase coating method such as dip coating or electrolytic deposition. Where required, the conductive film may be formed with patterns. The conductive film formed on the conductive base plate or on such a non-conductive base plate as mentioned above is utilized as an electrode (simply as the “first electrode” hereinafter).

Where required, other films may be further formed on the base plate. For example, there may be formed an adhesive layer merely for improving the adhesion to the base plate, an undercoating layer for smoothing unevenness of the base plate surface, and an intermediate layer which offers all of those functions.

As the material for forming such a film, no limitation is placed thereon, but there may be used any of known materials such as, for example, polyethylene, polypropylene, acryl, methacryl, polyamide, vinyl chloride, vinyl acetate, phenol, polycarbonate, polyurethane, polyimide, vinylidene chloride, polyvinyl acetal, vinyl chloride-vinyl acetate copolymer, polyvinyl alcohol, polyester, nitrocellulose, casein, gelatin, polyglutamic acid, starch, starch acetate, amino-starch, polyacrylic acid, polyacrylamide, zirconium chelate compound, titanyl chelate compound, titanyl alkoxide compound, organotitanyl compound, and silane coupling agent.

In the case where the non-linear optical material of the present invention is allowed to function also as a core layer in a waveguide in addition to the function of the electro-optical characteristic inherent therein, a clad layer (simply as “lower clad layer” hereinafter) may be formed between the core layer constituted by the non-linear optical material of the present invention and the base plate.

The lower clad layer is not specially limited as long as it is lower in refractive index than the core layer, that is, as long as the core layer/lower clad layer interface is not rendered non-uniform by elution or swelling at the time of applying the coating solution to the surface of the lower clad layer. As the material of such a lower clad layer there preferably is employed any of various acryl-, epoxy-, and silicone-based UV curing resins.

After the core layer is formed using the non-linear optical material of the present invention there may be further formed an upper clad layer in the same manner as above. The simplest slab waveguide can be constituted by the construction of base plate/lower clad layer/upper clad layer. After formation of the core layer, it is also possible to form the core layer into a channel type waveguide by a known method using a semiconductor process technique such as reactive ion etching (RIE) and photolithography.

Further, there may be adopted a photobleaching method wherein a part of the core layer is irradiated with light such as UV light to change the refractive index of the irradiated portion, thereby forming a channel. The timing for photobleaching may be just after formation of the core layer or after laminating an upper clad layer onto the core layer.

Thereafter, the other electrode (simply as the “second electrode” hereinafter) for input signal is formed in a desired area on the surface of the upper clad layer, whereby it is possible to form a basic electro-optical device.

Within the matrix, the chromophore portion of the non-linear optical material according to the present invention is fixed in three-dimensions in a poled (oriented) state. Therefore, deterioration such as orientation relaxation after poling treatment is difficult to occur against external energies such as heat and light involved in various processing such as the formation of the upper clad layer, the formation of channel by RIE or photobleaching, and the formation of the upper electrode.

In forming a channel type waveguide in the manner described above, known device structures such as linear type, Y branch type, coupling type, and Mach-Zehnder type can be constituted by selecting suitable waveguide forming methods. Thus, the non-linear optical material of the present invention can be applied to various known optical devices, including optical switch (branch, mix), optical modulator, and wave front transformer.

For applying the non-linear optical material of the present invention to a photorefractive device, a film of the non-linear optical material is formed on a substrate in the same way as above. As is the case with the electro-optical element, a certain intermediate layer may be formed between the substrate and the non-linear optical material. The non-linear optical material is applicable to both transparent and opaque substrates and likewise to both transmission type and reflection type. For application to a transmission type device it is necessary for the substrate to be transparent to light of the wavelength used. For use as a photorefractive device, poling treatment is not always necessary.

The present invention will be described below more concretely by way of working Examples thereof, provided the invention is not limited to the following Examples. Examples, Comparative Examples, poling treatment, evaluation of deterioration with time of poling, evaluation of electro-optical characteristic, evaluation of pot life, and evaluation of film formability, will be described below in this order.

### EXAMPLE 1

0.2 parts by mass of an ion-exchange resin (Amberlyst 15E) as a solid catalyst was added into a stock solution as an intimately mixed and dissolved solution of the following composition and reaction was allowed to take place with stirring at a room temperature for one hour. Subsequently, the ion-exchange resin was filtered off through a membrane filter to afford a coating solution in Example 1, which may hereinafter be referred to simply as “coating solution A.”

A silicon substituent-free organic non-linear molecule shown in Formula (1-1): 0.2 parts by mass

A silicon substituent-containing matrix-forming molecule shown in Formula (3-3): 1.6 parts by mass

Distilled water: 0.08 parts by mass

Ethanol: 4 parts by mass

Tetrahydrofuran: 3 parts by mass

The coating solution A thus prepared was immediately transferred into a hermetically sealed vessel and was stored at a room temperature in the air until the start of coating. In this hermetically sealed state, pot life was checked by visual observation of deposit and was found to be about 72 hours.

Next, the coating solution A before exhaustion of its pot life was applied by spin coating to an ITO film-formed surface of an ITO film-coated glass base (1 mm thick, surface resistance value: 10 Ω/□), then air-dried for 10 minutes, and was thereafter vacuum-dried within a vacuum desiccator for 12 hours. Two such treated glass substrates were fabricated.

Of the two substrates after vacuum drying, one was heated in a blast drier at 150° C. for one hour and was cured thereby to afford a cured film 1-1. The other substrate was placed on a hot plate and was subjected to both poling treatment and curing treatment by heating the hot plate simultaneously to afford a cured film 1-2. The details of the poling treatment will be described later.

Both cured films 1-1 and 1-2 were clean lustrous films, having no visual defects. Both were about 2.0 μm thick.

As to the deterioration with time of poling of the cured film 1-2, an order parameter just after its formation and an order parameter after storage in a dark place for 10 days were each 0.12, proving no occurrence of orientation relaxation of chromophore. Further, an electro-optical characteristic was confirmed as to the cured film 1-2 having been subjected to poling treatment.

### EXAMPLE 2

0.2 parts by mass of an ion-exchange resin (Amberlyst 15E) as a solid catalyst was added into a stock solution as an intimately mixed and dissolved solution of the following composition and reaction was allowed to take place with stirring at a room temperature for 24 hours. Subsequently, the ion-exchange resin was filtered off through a membrane filter.

Next, 0.02 parts by mass of aluminum triacetylacetonate as a curing agent was added into the filtered solution, followed by stirring, to afford a coating solution in Example 2, which may hereinafter be referred to simply as “coating solution B.”

A silicon substituent-free organic non-linear molecule shown in Formula (1-1): 0.2 parts by mass

A silicon substituent-containing matrix-forming molecule shown in Formula (3-3): 1.6 parts by mass

Distilled water: 0.08 parts by mass

Ethanol: 4 parts by mass

Tetrahydrofuran: 3 parts by mass

The coating solution B thus prepared was immediately transferred into a hermetically sealed vessel and was stored at a room temperature in the air until the start of coating. In this hermetically sealed state, pot life was checked by visual observation of deposit and was found to be about 200 hours.

Next, using the coating solution B before exhaustion of its pot life, a film was formed on an ITO film-coated glass base in the same way as in Example 1 and there were obtained a cured film 2-1 having been subjected to only curing treatment and a cured film 2-2 having been subjected to both poling treatment and curing treatment.

Both cured films 2-1 and 2-2 were clean lustrous films, having no visual defects. Both were about 2.0 μm thick.

As to the deterioration with time of poling of the cured film 2-2, an order parameter just after its formation and an order parameter after storage in a dark place for 10 days were each 0.12, proving no occurrence of orientation relaxation of chromophore. Further, an electro-optical characteristic was confirmed as to the cured film 2-2 having been subjected to poling treatment.

### EXAMPLE 3

0.2 parts by mass of an ion-exchange resin (Amberlyst 15E) as a solid catalyst was added into a stock solution as an intimately mixed and dissolved solution of the following composition and reaction was allowed to take place with stirring at a room temperature for 24 hours. Subsequently, the ion-exchange resin was filtered off through a membrane filter.

Next, 0.02 parts by mass of tetrabutoxy titanate as a curing agent was added into the filtered solution, followed by stirring, to afford a coating solution in Example 3, which may hereinafter be referred to simply as “coating solution C.”

An silicon substituent-free organic non-linear molecule shown in Formula (1-1): 0.2 parts by mass

A silicon substituent-containing matrix-forming molecule shown in Formula (3-3): 1.6 parts by mass

Distilled water: 0.08 parts by mass

Ethanol: 4 parts by mass

Tetrahydrofuran: 3 parts by mass

The coating solution C thus prepared was immediately transferred into a hermetically sealed vessel and was stored at a room temperature in the air until the start of coating. In this hermetically sealed state, pot life was checked by visual observation of deposit and was found to be about 10 hours.

Next, using the coating solution C before exhaustion of its pot life, a film was formed on an ITO film-coated glass base in the same way as in Example 1 and there were obtained a cured film 3-1 having been subjected to only curing treatment and a cured film 3-2 having been subjected to both poling treatment and curing treatment.

Both cured films 3-1 and 3-2 were clean lustrous films, having no visual defects. Both were about 2.0 μm thick.

As to the deterioration with time of poling of the cured film 3-2, an order parameter just after its formation and an order parameter after storage in a dark place for 10 days were each 0.12, proving no occurrence of orientation relaxation of chromophore. Further, an electro-optical characteristic was confirmed as to the cured film 3-2 having been subjected to poling treatment.

### EXAMPLE 4

0.6 parts by mass of an ion-exchange resin (Amberlyst 15E) as a solid catalyst was added into a stock solution as an intimately mixed and dissolved solution of the following composition and reaction was allowed to take place with stirring at a room temperature for one hour. Subsequently, the ion-exchange resin was filtered off through a membrane filter.

Thereafter, 0.06 parts by mass of aluminum trisacetylacetonate as a curing agent and 0.06 parts by mass of acetylacetone were added into the filtered solution to afford a coating solution in Example 4, which may hereinafter be referred to simply as “coating solution D.”

A silicon substituent-free organic non-linear molecule shown in Formula (1-1): 1 part by mass

A silicon substituent-containing matrix-forming molecule shown in Formula (3-6): 1.6 parts by mass

Distilled water: 2.5 parts by mass

Methanol: 6 parts by mass

Tetrahydrofuran: 18 parts by mass

The coating solution D thus prepared was immediately transferred into a hermetically sealed vessel and was stored at a room temperature in the air until the start of coating. In this hermetically sealed state, pot life was checked by visual observation of deposit and was found to be about 240 hours.

Next, using the coating solution D before exhaustion of its pot life, a film was formed on an ITO film-coated glass base in the same way as in Example 1 and there were obtained a cured film 4-1 having been subjected to only curing treatment and a cured film 4-2 having been subjected to both poling treatment and curing treatment.

In the poling treatment and curing treatment performed in forming the cured film 4-2, the temperature was raised from 30° C. to 150° C. stepwise in increments of 20° C. over a one-hour period in an Ar gas atmosphere. Other conditions were the same as in Example 1.

Both cured films 4-1 and 42 were clean lustrous films, having no visual defects. Both were about 2.0 μm thick.

As to the deterioration with time of poling of the cured film 4-2, an order parameter just after its formation and an order parameter after storage in a dark place for 30 days were each 0.14, proving no occurrence of orientation relaxation of chromophore. Further, an electro-optical characteristic was confirmed as to the cured film 4-2 having been subjected to poling treatment.

### EXAMPLE 5

0.6 parts by mass of an ion-exchange resin (Amberlyst 15E) as a solid catalyst was added into a stock solution as an intimately mixed and dissolved solution of the following composition and reaction was allowed to take place with stirring at a room temperature for one hour. Subsequently, the ion-exchange resin was filtered off through a membrane filter.

Thereafter, 0.06 parts by mass of aluminum trisacetylacetonate as a curing agent and 0.06 parts by mass of acetylacetone were added into the filtered solution to afford a coating solution in Example 5, which may hereinafter be referred to simply as “coating solution E.”

A silicon substituent-containing organic non-linear molecule shown in Formula (2-3): 1 part by mass

A silicon substituent-containing matrix-forming molecule shown in Formula (3-6): 1.6 parts by mass

Distilled water: 2.5 parts by mass

Methanol: 6 parts by mass

Tetrahydrofuran: 18 parts by mass

The coating solution E thus prepared was immediately transferred into a hermetically sealed vessel and was stored at a room temperature in the air until the start of coating. In this hermetically sealed state, pot life was checked by visual observation of deposit and was found to be about 200 hours.

Next, using the coating solution E before exhaustion of its pot life, a film was formed on an ITO film-coated glass base in the same way as in Example 1 and there were obtained a cured film 5-1 having been subjected to only curing treatment and a cured film 5-2 having been subjected to both poling treatment and curing treatment.

In the poling treatment and curing treatment performed in forming the cured film 5-2, the temperature was raised from 30° C. to 150° C. stepwise in increments of 20° C. over a one-hour period in an Ar gas atmosphere. Other conditions were the same as in Example 1.

Both cured films 5-1 and 5-2 were clean lustrous films, having no visual defects. Both were about 2.0 μm thick.

As to the deterioration with time of poling of the cured film 5-2, an order parameter just after its formation and an order parameter after storage in a dark place for 30 days were each 0.12, proving no occurrence of orientation relaxation of chromophore. Further, an electro-optical characteristic was confirmed as to the cured film 5-2 having been subjected to poling treatment.

### EXAMPLE 6

0.1 parts by mass of an ion-exchange resin (Amberlyst 15E) as a solid catalyst was added into a stock solution as an intimately mixed and dissolved solution of the following composition and reaction was allowed to take place with stirring at a room temperature for one hour. Subsequently, the ion-exchange resin was filtered off through a membrane filter.

Next, 0.01 parts by mass of aluminum triacetylacetonate as a curing agent was added into the filtered solution to afford a coating solution in Example 6, which may hereinafter be referred to as “coating solution F.”

A silicon substituent-containing organic non-linear molecule shown in Formula (2-1): 1 part by mass

Distilled water: 0.2 parts by mass

Methanol: 1 part by mass

Tetrahydrofuran: 1 part by mass

Cyclohexanone: 1.8 parts by mass

The coating solution F thus prepared was immediately transferred into a hermetically sealed vessel and was stored at a room temperature in the air until the start of coating. In this hermetically sealed state, pot life was checked by visual observation of deposit and was found to be about 200 hours.

Next, using the coating solution F before exhaustion of its pot life, a film was formed on an ITO film-coated glass base in the same way as in Example 1 and there were obtained a cured film 6-1 having been subjected to only curing treatment and a cured film 6-2 having been subjected to both poling treatment and curing treatment.

In the poling treatment and curing treatment performed in forming the cured film 6-2, the temperature was raised from 30° C. to 150° C. stepwise in increments of 20° C. over a one-hour period in an Ar gas atmosphere. Other conditions were the same as in Example 1.

Both cured films 6-1 and 6-2 were clean lustrous films, having no visual defects. Both were about 2.0 μm thick.

As to the deterioration with time of poling of the cured film 6-2, an order parameter just after its formation and an order parameter after storage in a dark place for 30 days were each 0.2, proving no occurrence of orientation relaxation of chromophore. Further, an electro-optical characteristic was conformed as to the cured film 6-2 having been subjected to poling treatment.

### COMPARATIVE EXAMPLE 1

0.08 parts by mass of concentrated hydrochloric acid as a homogeneous catalyst was added instead of a solid catalyst into a stock solution as an intimately mixed and dissolved solution of the following composition, followed by stirring thoroughly, to afford a coating solution in Comparative Example 1, which may hereinafter be referred to simply as “coating solution 1.”

A silicon substituent-containing organic non-linear molecule shown in Formula (1-1): 1.0 part by mass

A silicon substituent-containing matrix-forming molecule shown in Formula (3-3): 1.6 parts by mass

Ethanol: 4 parts by mass

Tetrahydrofuran: 3 parts by mass

Since the reaction of the coating solution 1 proceeds rapidly just after the addition of concentrated hydrochloric acid, in about three minutes after its preparation the coating solution 1 was spin-coated onto an ITO film-formed surface of an ITO film-coated glass base in the same manner as in Example 1.

However, during 10-minute air drying, there occurred a partial aggregation in the film and the film became a very uneven, non-uniform film. Thereafter, the coated base was heated in a blast drier at 150° C. for one hour. As a result, although there was partially formed a film, fine stripe-like cracks were developed and the coating was partially stripped off. Further, a light touch with a spatula sometimes caused peeling.

On the other hand, upon lapse of 10 minutes after the addition of concentrated hydrochloric acid, the coating solution 1 was found to be heterogeneous even visually. Even when the coating solution 1 was spin-coated onto a base, there were observed only fine aggregates and film was not formed.

Hence, it is understood that, in a conventional method, pot life is shortened and it is difficult to from a uniform film with good reproducibility.

### COMPARATIVE EXAMPLE 2

In Example 4, 0.05 parts by mass of concentrated hydrochloric acid was added instead of the ion-exchange resin into the stock solution. Other conditions were the same as in Comparative Example 1. Spin-coating performed in three minutes after the start of reaction afforded a film though not uniform, while spin-coating performed in 15 minutes failed to form a film, and aggregation occurred heavily. The film formed in three minutes was very uneven in thickness and unevenness in color caused by unevenness in density of the resulting non-linear optical material was conspicuous, not withstanding any further evaluation.

### COMPARATIVE EXAMPLE 3

In Example 6, 0.03 parts by mass of concentrated hydrochloric acid was added instead of the ion-exchange resin into the stock solution. Other conditions were the same as in Comparative Example 1. Spin-coating performed in three minutes after the start of reaction afforded a film though not uniform, while spin-coating performed in 15 minutes failed to form a film, and aggregation occurred heavily. The film formed in three minutes was very uneven in thickness and unevenness in color caused by unevenness in density of the resulting non-linear optical material was conspicuous, not withstanding any further evaluation.

(Poling Treatment)

In poling treatment (and curing treatment), a base including cured film/ITO film/glass base was put on a hot plate so that a cured film-formed surface faced up, and a wire electrode and a grid electrode were disposed on the cured film so that chromophore could be oriented in the film thickness direction.

Conditions for poling were set as follows. Voltage applied to the wire electrode was 5 kV, voltage applied to the grid electrode was 150 V, and the distance between the cured film surface formed on the ITO film-formed surface side of the glass base and the grid electrode was 2 mm.

Under such conditions, the hot plate temperature was raised from 30° C. to 150° C. over a one-hour period after the start of voltage application, then was held at 150° C. for 30 minutes, thereafter returned to a room temperature over a period of about 15 minutes, and then the application of voltage was stopped. In this way both poling treatment and curing treatment by heating the hot plate were carried out simultaneously. In Examples 4 to 6, the procedure of curing treatment using the hot plate is somewhat different as already mentioned.

(Checking Deterioration with Time of Poling)

Both a cured film (simply as “cured film N” hereinafter) with chromophore oriented randomly without poling treatment and a cured film (simply as “cured film P” hereinafter) with chromophore oriented in the film thickness direction by poling treatment were measured for absorption spectrum using a spectrophotometer (Hitachi U-3000) just after their formation. Then, an order parameter indicating the degree of chromophore orientation was calculated from the wavelength λmax corresponding to maximum absorption of the cured films N and P.

Next, after storage in a dark place for 10 days or more, the cured films N and P were measured for order parameter in the same manner as above, whereby whether or not there occurred deterioration with time of poling was checked on the basis of the following criterion, the results of which are shown in Table 1.

B: Percent lowering in order parameter after storage in a dark place for 10 days or more relative to the order parameter just after film formation is less than 15%.

C: Percent lowering in order parameter after storage in a dark place for 10 days or more relative to the order parameter just after film formation is 15% or more.

To be more specific, the above order parameter is defined like the following equation (1):

φ=1−A_{P}/A_{N} (1)

where φ stands for an order parameter, A_{P} stands for absorbance at the wavelength λmax of the cured film P having been subjected to poling treatment, and A_{N} stands for absorbance at the wavelength λmax of the cured film N not having been subjected to poling treatment.

(Evaluation of Electro-Optical Characteristic)

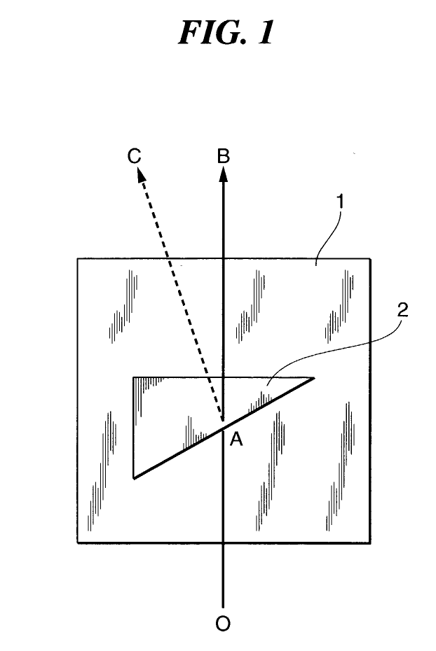

An Au electrode was formed in a wedge shape as in FIG. 1 on the surface of the cured film P formed on the ITO film-formed surface of the glass base. FIG. 1 is a schematic diagram illustrating how to evaluate an electro-optical characteristic of the cured film P. In the same figure, the reference numeral 1 denotes the cured film P formed on the ITO film surface (not shown), the numeral 2 denotes the Au electrode formed on the surface of the cured film P1, and arrows OAB and OAC represent optical paths of He—Ne laser beam (wavelength: 633 nm) which is incident in the direction of symbol A from symbol O.

Evaluation of an electro-optical characteristic was conducted by radiating a laser beam in the symbol A direction from symbol O nearly perpendicularly to an end face of the cured film P and by subsequently observing a change in optical path upon application of a voltage of 10 V to 100 V to the wedge-shaped electrode 2.

More specifically, a check was made to see if the linear optical path indicated by the arrow OAB direction changed to the arrow OAC direction and became non-linear or not upon voltage application to the wedge-shaped electrode 2, followed by evaluation based on the following criterion, the results of which are shown in Table 1.

B: Non-linearity of optical path was confirmed when voltage was applied to the wedge-shaped electrode.

C: Non-linearity of optical path was not confirmed when voltage was applied to the wedge-shaped electrode.

(Evaluation of Pot Life)

Pot life was evaluated by sealing a coating solution after preparation thereof into a transparent vessel and by subsequently measuring the time until visual confirmation of deposit in the sealed state. The evaluation was made on the basis of the following criterion, the results of which are shown in Table 1.

A: Pot life is 24 hours or larger.

B: Pot life is 8 hours or larger.

C: Pot life is shorter than 8 hours.

(Evaluation of Film Formability)

Both cured films N and P were evaluated for film formability by visually checking the presence or absence of defects such as cracks and by testing whether film peeling occurred or not when the surfaces of the cured films were rubbed with a spatula. The evaluation was made on the basis of the following criterion, the results of which are shown in Table 1.

B: Neither defects such as cracks nor film peeling was observed by visual check.

C: Defects such as cracks and/or film peeling were (was) observed by visual check.

TABLE 1

| | Matrix-forming Component in Stock Solution | | | | | | | | |
|---|---|---|---|---|---|---|---|---|---|
| | | | Silicon | | | Evaluation of Characteristics | | | |
| | Organic Non-linear Molecule | | Substituent- | Catalyst used | | | | | Electro- |
| | (containing | containing | | | Homo- | | Film | Deterioration | Optical |
| | silicon | (not containing | Matrix-forming | | geneous | Pot | Formability | over Time | Charac- |
| | substituent) | silicon substituent) | Molecule | Solid Catalyst | Catalyst | Life | (Formability) | of Polishing | teristic |
| Example 1 | — | Compound of | Compound of | Ion-Exchange Resin | — | A | B | B | B |
| | | Formula (1-1) | Formula (3-3) | (Amberlyst 1SE) | | | | | |
| Example 2 | — | Compound of | Compound of | Ion-Exchange Resin | — | A | B | B | B |
| | | Formula (1-1) | Formula (3-3) | (Amberlyst 15E) | | | | | |
| Example 3 | — | Compound of | Compound of | Ion-Exchange Resin | — | B | B | B | B |
| | | Formula (1-1) | Formula (3-3) | (Amberlyst iSE) | | | | | |
| Example 4 | — | Compound of | Compound of | Ion-Exchange Resin | — | A | B | B | B |
| | | Formula (1-1) | Formula (3-6) | (Amberlyst 15E) | | | | | |
| Example 5 | Compound of | — | Compound of | Ion-Exchange Resin | — | A | B | B | B |
| | Formula (2-3) | | Formula (3-6) | (Amberlyst 15E) | | | | | |
| Example 6 | Compound of | — | — | Ion-Exchange Resin | — | A | B | B | B |
| | Formula (2-1) | — | — | (Amberlyst 15E) | | | | | |
| Comparative | — | Compound of | Compound of | — | Concentrated | C | C | — | — |
| Example 1 | | Formula (1-1) | Formula (3-3) | | Hydrochloric | | | | |
| | | | | | Acid | | | | |
| Comparative | — | Compound of | Compound of | — | Concentrated | C | C | — | — |
| Example 2 | | Formula (1-1) | Formula (3-6) | | Hydrochloric | | | | |
| | | | | | Acid | | | | |
| Comparative | Compound of | — | — | — | Concentrated | C | C | — | — |
| Example 3 | Formula (2-1) | | | | Hydrochloric | | | | |
| | | | | | Acid | | | | |

As set forth above, according to the first embodiment it is possible to provide a coating solution for production of a non-linear optical material, the non-linear optical material, and a method for producing the non-linear optical material, which coating solution and method are superior in workability at the time of forming the non-linear optical material by a sol-gel method and which non-linear optical material formed is superior in formability.

According to the second embodiment it is possible to provide a coating solution for the production of a non-linear optical material, the non-linear optical material, and a method for producing the non-linear optical material, wherein optimization of a non-linear optical characteristic of the non-linear optical material formed by a sol-gel method and other characteristics than the non-linear optical characteristic is easy and the relaxation of orientation of chromophore can be prevented.

The entire disclosure of Japanese Patent Application No. 2002-078861 filed on Mar. 20, 2002 including specification, claims, drawings and abstract is incorporated herein by reference in its entirety.

What is claimed is:

1. A preparing method of a coating solution comprising the steps of:
preparing a solution containing at least an organic non-linear molecule having one or more hydrolyzable silicon substituent groups;
contacting the solution with a solid catalyst for sufficient time; and
separating the solution from the solid catalyst.

2. A preparing method of a coating solution comprising the steps of:
preparing a solution containing at least an organic matrix-forming molecule having one or more hydrolyzable silicon substituent groups and a non-linear organic molecules;
contacting the solution with a solid catalyst for sufficient time; and
separating the solution from the solid catalyst.

3. The preparing method according to claim 2,
wherein the organic non-linear molecule contains one or more hydrolyzable silicon substituent groups.

4. The preparing method according to claim 2,
wherein the matrix-forming molecule contains two or more hydrolyzable silicon substituent groups.

5. A non-linear optical coating solution processed by the preparing method according to claim 1.

6. A non-linear optical coating solution processed by the preparing method according to claim 2.

7. A non-linear optical material produced using the coating solution described in claim 5.

8. A non-linear optical material produced using the coating solution described in claim 6.

9. An optical material produced using the coating solution described in claim 5.

10. An optical material produced using the coating solution described in claim 6.
